(19) United States
(12) Patent Application Publication
(10) Pub. No.: US 2013/0297807 A1
(43) Pub. Date: Nov. 7, 2013

(54) SYSTEMS AND METHODS FOR SERVING APPLICATION PROGRAMS TO DEVICES

(71) Applicants: Steven Darnell Chavis, Dardenne Prairie, MO (US); Kenneth Ray, Celebration, FL (US)

(72) Inventors: Steven Darnell Chavis, Dardenne Prairie, MO (US); Kenneth Ray, Celebration, FL (US)

(21) Appl. No.: 13/462,594

(22) Filed: May 2, 2012

(51) Int. Cl. G06F 15/16

(52) U.S. Cl. 709/227

(57) ABSTRACT

A computer system includes a computer server having memory, an operating system program, and an application program stored in said memory and compatible with the operating system program. The computer server is configured to establish via a communication network a direct connection with a client device having an operating system program different than the server's operating system program to permit a user of the client device to execute the application program on the computer server.

### FIELD

The present disclosure relates to systems and methods for serving application programs to devices.

### BACKGROUND

This section provides background information related to the present disclosure which is not necessarily prior art.

Application program development and implementation may include two known approaches. One approach includes writing a specific application program for a device according to the device's operating system. In this approach, the specific application program is installed and executed on the device. Accordingly, in this approach, one must write numerous application programs having the same functionality for each different device according to each different device's operating system.

Alternatively, another approach includes writing a browser based application program. The browser based application program is an application program accessed over the internet or intranet and may be restricted by the browser of the device accessing the program.

### SUMMARY

This section provides a general summary of the disclosure, and is not a comprehensive disclosure of its full scope or all of its features.

According to one aspect of the present disclosure, a computer system includes a computer server having memory, an operating system program, and an application program stored in the memory and compatible with the operating system program. The computer server is configured to establish via a communication network a direct connection with a client device having an operating system program different than the server's operating system program to permit a user of the client device to execute the application program on the computer server.

According to another aspect, a client device includes an operating system program and client software. The client software is configured to communicate via a direct connection over a communication network with a computer server having an operating system program different than the client device's operating system program to execute an application program compatible with the computer server's operating system program on the computer server.

According to yet another aspect, a method for serving data via a direct connection over a communication network from a computer server to a client device is disclosed. The computer server includes an operating system program, and an application program compatible with the operating system program. The client device includes an operating system program different than the server's operating system program. The method includes (a) transmitting to the client device data representing a screen graphic of the application program to be displayed on the client device, and (b) receiving from the client device data representing a selection by a user of the client device.

According to still another aspect, a method of receiving data via a direct connection over a communication network by a client device from a computer server is disclosed. The client device includes an operating system program. The computer server includes an operating system program different than the client device's operating system program and an application program compatible with the computer server's operating system program. The method includes (a) receiving from the computer server data representing a screen graphic of the application program to be displayed on the client device, and (b) transmitting to the computer server data representing a selection by a user of the client device.

Further aspects and areas of applicability will become apparent from the description provided herein. It should be understood that various aspects of this disclosure may be implemented individually or in combination with one or more other aspects. It should also be understood that the description and specific examples herein are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of a computer system including a client device coupled to a server via a communication network according to one example embodiment of the present disclosure.

FIG. 2 is a block diagram of the computer system of FIG. 1 including more than one client device coupled to the server via the communication network according to another example embodiment.

FIG. 3 is a block diagram of the computer system of FIG. 2 including more than one server according to yet another example embodiment.

FIG. 4 is a block diagram of one of the servers of FIG. 3 according to still another example embodiment.

FIG. 5 is a block diagram of the computer system of FIG. 3 including more than one server according still yet another example embodiment.

FIG. 6 is a block diagram illustrating communication between the servers and the device of FIG. 1.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

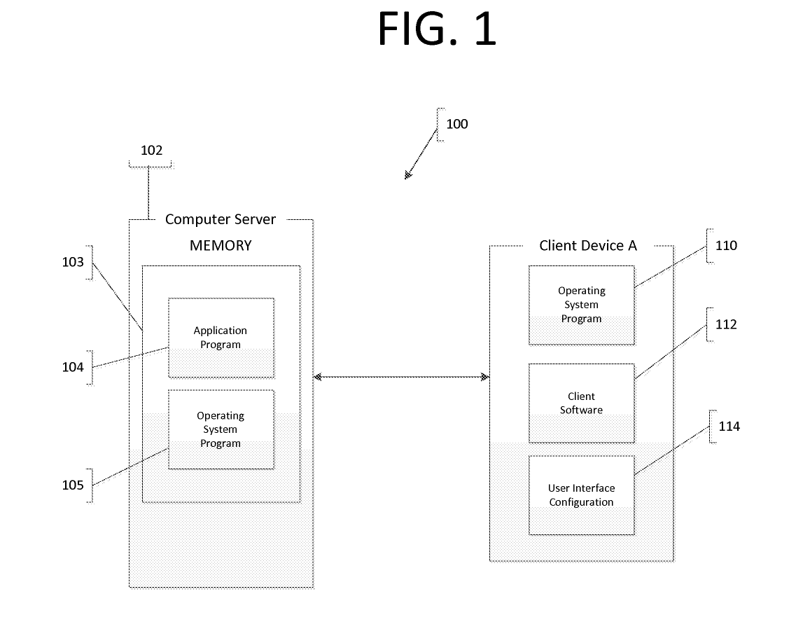

A computer system according to one example embodiment of the present disclosure is illustrated in FIG. 1 and indicated generally by reference number 100. As shown in FIG. 1, the computer system 100 includes a computer server 102 and a client device A in communication with the computer server 102 via a communication network. The computer server 102 includes memory 103, an operating system program 105, and an application program 104 (i.e., an executable program) stored in the memory 103 and compatible with the operating system program 105 of the computer server 102.

The client device A includes an operating system program 110, a user interface configuration 114, and client software 112 compatible with the operating system program 110 of the client device A. The client software 112 is specific to the client device A including the user interface configuration 114 and the operating system program 110.

The operating system program 110 may or may not be compatible with the operating system program 105 of the computer server 102. Thus, the operating system program 110 of the client device A may be different from and/or not compatible with the operating system program 105 of the computer server 102.

The user interface configuration 114 may include any suitable client device configuration including visual configurations (e.g., display size, display resolution, etc.), audio configurations, software configurations, control configurations (e.g., keystrokes, movements of a computer mouse, selection with a touchscreen, etc.), etc.

The application program 104 may be generic to the client device A. That is, the application program 104 may not be specifically configured for any particular client device or any particular operating system program.

The computer server 102 is configured to establish via a communication network a direct connection with the client device A to permit a user of the client device A to execute the application program 104 on the computer server 102. In some embodiments, the computer server 102 establishes the direct connection with the client software 112 via the communication network. The direct connection does not require a web browser for connecting the computer server 102 and the client software 112 of the client device A. That is, the client software 112 is non-browser based software.

The computer server 102 is configured to receive data identifying the user interface configuration 114 of the client device A. For example, the computer server 102 may receive from the client device A data representing a display size, client software 112, etc.

The computer server 102 is further configured to transmit to the client device A data representing a screen graphic of the application program 104 to be displayed on the client device A. For example, X, Y coordinates of the screen graphic displayed on a display of the client device A may be transmitted to the client A.

Further, the computer server is configured to receive from the client device data representing a selection by a user of the client device. For example, a user of the client device A may touch, select, point, click, etc. the display to identify an X, Y coordinate which is transmitted to the computer server 102. Thus, the data representing the selection may identify a portion of the screen graphic selected by the user of the client device A.

This process allows the application program 104 to maintain its functionality, appearance, etc. while being displayed via the screen graphic on the client device A even if the application program 104 is not compatible (i.e., not designed to be installed and executed) with the operating system program 110 of the client device A.

In some embodiments, only the data representing the screen graphic (e.g., the X, Y coordinates of the screen graphic) or data representing the selected portion of the screen graphic by the user of the client device A is transferred between the computer server 102 and the client device A. This provides greater security, control, management, etc. of the computer system 100.

Alternatively, data representing inputs not relating to the X, Y coordinates may be transmitted to the computer server 102. For example, the user of the client device A may utilize keyboard inputs while employing the application program 104. Thus, data representing the keyboard inputs may be transferred between the computer server 102 and the client device A.

Further, some or all documents, information, data, etc. of the application program 104 may be saved on the computer server 102. In other embodiments, some or all documents, information, data, etc. of the application program 104 may be locally saved on the client device A. Alternatively, some documents, information, data, etc. may be saved on the computer server 102 while other documents, information, data, etc. may be locally saved on the client device A.

For exemplary purposes only, the application program 104 may be a blackjack game application. After the computer server 102 identifies the user interface configuration 114 of the client device A, the blackjack game is executed on the computer server 102. The computer server 102 serves a screen graphic of a main menu of the blackjack game to the client software 112 to be displayed on the client device A. A user of the client device A may then select a “deal cards” option on the screen graphic of the main menu. The computer server 102 then responds by serving a new screen graphic of dealt cards to the client software 112 to be displayed on the client device A. The user may then select a “hold” option or a “hit” option on the new screen graphic. The computer server 102 then responds by serving another new screen graphic of the selected option to the client software 112 to be displayed on the client device A. This process may be repeated as desired by the user.

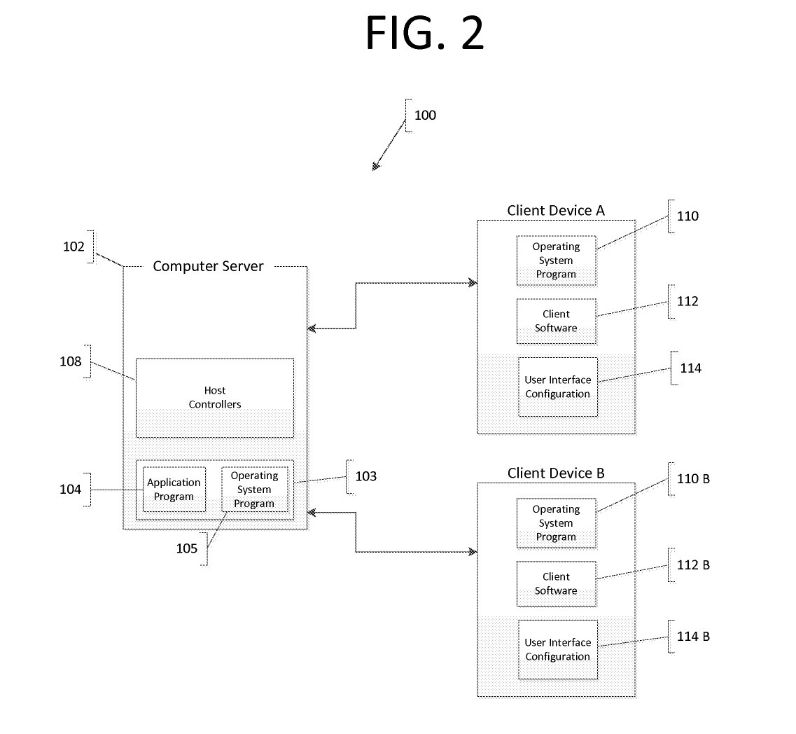

FIG. 2 illustrates an implementation of the computer system 100 of FIG. 1 having more than one client device configured to communicate with the computer server 102. In the example of FIG. 2, client device B includes an operating system program 110B, client software 112B compatible with the operating system program 110B and a user interface configuration 114B. The operating system program 110B may or may not be different from the operating system program 105 of the computer server 102 or the operating system program 110 of the client device A. Further, the user interface configuration 114B may or may not be different from the user interface configuration 114 of the client device A.

For example, the client device A may be an Apple® client device and the client device B may be a BlackBerry® client device. In that case, the client device A includes an Apple® operating system program and client software specific to the Apple® client device and to the Apple® operating system program while the client device B includes a BlackBerry® operating system program and client software specific to the BlackBerry® client device and to the BlackBerry® operating system program.

In the example of FIG. 2, the computer server 102 further includes one or more host controllers 108 for establishing the direct connection with the client device A and the client device B. Each host controller is specific to the user interface configuration and the operating system program of each specific client device. Thus, the computer server 102 may serve via a specific host controller the application program 104 to each client device A, B.

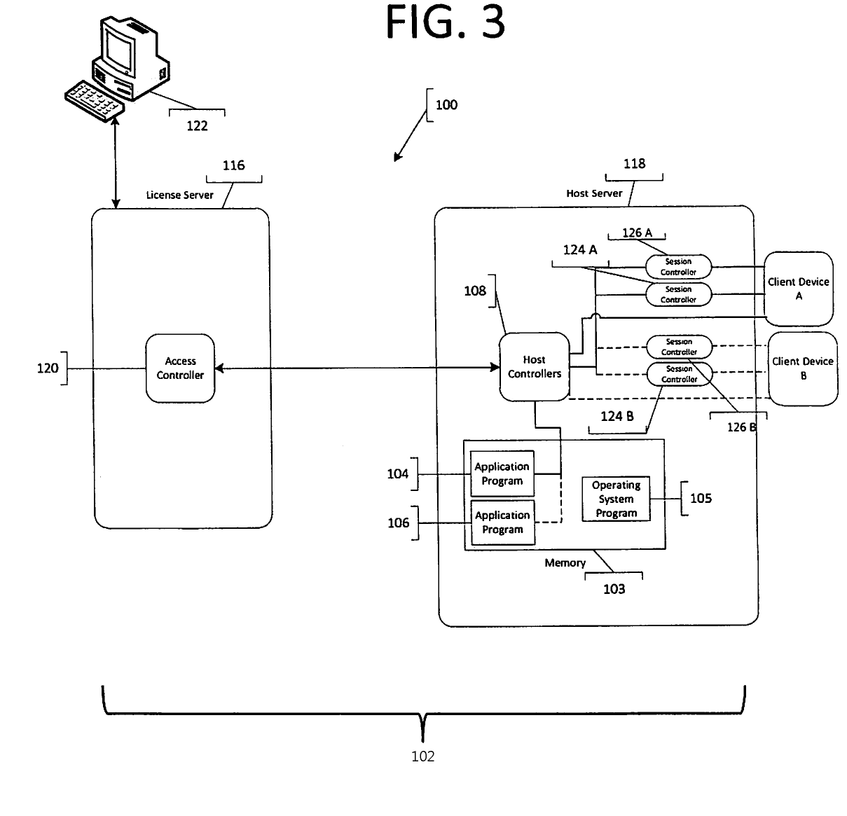

FIG. 3 illustrates an implementation of the computer system 100 of FIG. 2 having application programs 104, 106 stored in the memory 103 and compatible with the operating system program 105 of the computer server 102. The computer server 102 may execute the application programs 104, 106 which may or may not be compatible with the client devices A, B and serve screen graphics of the application programs 104, 106 to the client devices A, B. Alternatively, the computer system 100 may include any suitable number of application programs.

In the example of FIG. 3, one host controller (of the host controllers 108) is specific to the client device A. The specific host controller establishes session controllers 124A, 126A each time an application program is selected on the client device A. As shown in FIG. 3, the session controllers 124A, 126A are coupled to the specific host controller and to the client device A and may be employed to execute the application program 104. The session controllers 124A, 126A provide an interactive information exchange between the computer server 102 (via the specific host controller) and the client device A.

Further, another host controller (of the host controllers 108) may be specific to the client device B if client device B includes a different user interface configuration or a different operating system program from the client device A. The specific host controller for the client device B establishes session controllers 124B, 126B coupled the specific host controller and to the client device B (shown in FIG. 3 as phantom lines).

After the specific host controller for the client device A establishes the session controller 124A, 126A, the specific host controller may act as a proxy (i.e., an intermediary) between the client software 112 on the client device A and the session controllers 124A, 126A. That is, data received by the session controllers 124A, 126A from the client device A or data transmitted from the session controllers 124A, 126A to the client device A is via the specific host controller.

The specific host controller and the session controllers 124A, 126A may communicate by using an inter-process communication (IPC) method of shared memory. In the example of FIG. 3, two first in, first out (FIFO) shared memory communication channels may be opened between the specific host controller and the session controllers for communication. Alternatively, communication between the specific host controller and the session controllers may be implemented by any suitable method of communication, including remote procedure calls (e.g., Microsoft component object model (COM)). etc.

Although two session controllers are illustrated in FIG. 3 for each specific host controller, more or less session controllers may be employed.

Further, in the example of FIG. 3, the computer server 102 includes a license server 116 and a host server 118. Although the license server 116 and the host server 118 are shown as two separate servers located remotely from one another in FIG. 3, any suitable configuration may be employed. For example, the license server 116 and the host server 118 may be one server (e.g., the computer server 102) or more than two servers. Alternatively, the license server 116 and the host server 118 may be co-located at the same site, etc.

The license server 116 includes an access controller 120 for controlling access to the application programs 104, 106 on the computer server 102 by the client devices A, B. For example, the access controller 120 may control access to the application programs 104, 106 based on data received from the host server 118 (e.g., via a specific host controller of the host controllers 108).

The access controller 120 may serve a list of one or more accessible application programs to the client device A and a list of one or more accessible application programs to the client device B. The lists may include, for example, an icon associated with each accessible application program. Each list of accessible application programs may include the application programs 104, 106, may include only one of the application programs 104, 106 or may not include the application programs 104, 106. Further, the list of accessible application programs for the client device A may be the same or different from the list of accessible application programs for the client device B. Each accessible application program on the list of accessible application programs is not installed on the client devices A, B.

In this way, the computer server 102 via the access controller 120 may restrict access of the client device A to application programs on the list of accessible application programs served to the client device A. Likewise, the computer server 102 via the access controller 120 may restrict access of the client device B to application programs on the list of accessible application programs served to the client device B. Accordingly, because the client devices A, B are restricted to particular accessible application programs, the client devices A, B may not access a desktop, a virtual desktop, etc. of the computer server 102.

Further, communication between the computer server 102 and the client device A is provided by the specific host controller and session controllers 124A, 126A. Consequently, the computer system 100 is not required to include third party software (e.g., remote desktop services, etc.) to provide a communication process between the computer server 102 and the client device

A.

The access controller 120 is also coupled to a management system 122. The management system 122 allows a client administrator to access the access controller 120 for administration purposes. For example, the management system 122 may be employed to add applications to the list of accessible application programs, to register client devices (e.g., the client devices A, B), and to register and manage user accounts. The management system 122 may be, for example, a windows .net application that allows access to the access controller 120 via a web browser. Alternatively, the management system 122 may be any suitable application having any suitable communication method.

Data exchange between the client devices A, B and the specific host controller and/or the session controllers and between the specific host controller and the access controller 120 may be by transmission control protocol (TCP), including JavaScript Object Notation (JSON), Hypertext Transfer Protocol (HTTP) or any other suitable protocol.

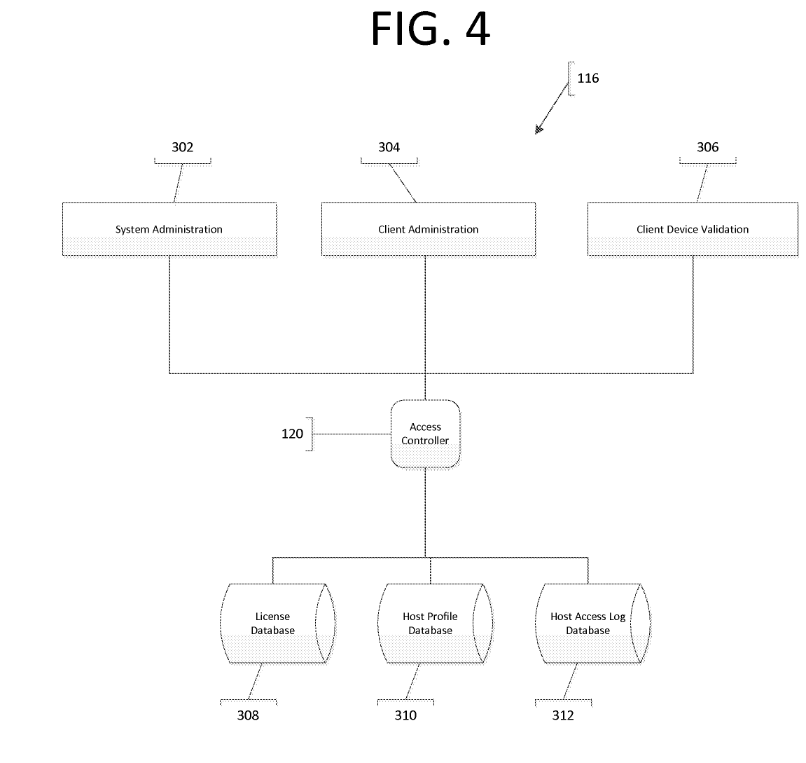

FIG. 4 illustrates the license server 116 of FIG. 3 accordingly to yet another example embodiment. As shown in FIG. 4, the access controller 120 may be in communication with one or more databases and one or more administrative systems.

The one or more databases may include a license database 308, a host profile database 310 and a host access log database 312. The license database 308 may store information regarding licenses available, licenses in use, etc. The host profile database 310 may store information about the application programs, Internet Protocol (IP) addresses, etc. The host access log database 312 may store information regarding user names, passwords, application programs accessed, etc.

The one or more administrative systems may include a system administration 302, a client administration 304 and a client device validation 306. The system administration 302 may setup and control user accounts, host controllers, licenses, etc. of the computer system 100. The system administration 302 may be controlled remotely by, for example, the management system 122 or any other suitable administrator remote from the host server 118. The client administration 304 may provide user access to control and manage the client devices A, B, accessible application programs, configuration tables of the host controllers, etc. The client device validation 306 may be used to verify the client devices A, B, including the client software 112, 112B, to determine accessibility of application programs for each client device.

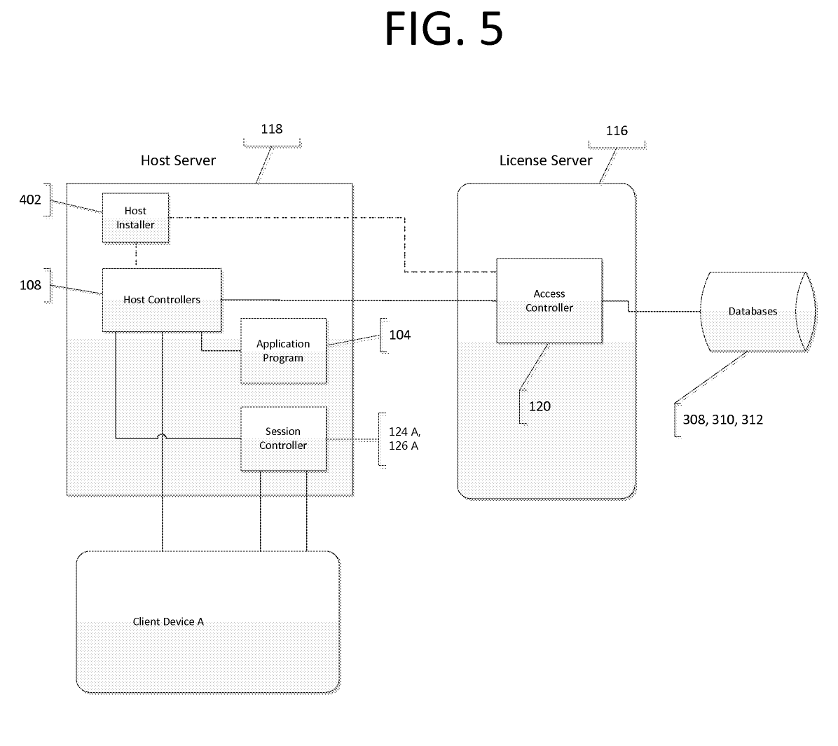

FIG. 5 illustrates the computer system 100 of FIG. 1 accordingly to another example embodiment. As shown in FIG. 5, the host server 118 includes a host installer 402 for installing a specific host controller from the host controllers 108 for a specific client device. In the example of FIG. 5, the host installer 402 installs a specific host controller for the client device A. Additionally and/or alternatively, the host installer 402 may install a specific host controller from the host controllers 108 for the client device B (not shown).

In some embodiments, the license server 116 may communicate with the host installer 402 to install the specific host controller from the host controllers 108. This allows the license server 116 to control the installation of specific host controllers.

Data exchange between the host installer 402 and the access controller 120 may be by TCP, including JSON, HTTP or any other suitable protocol.

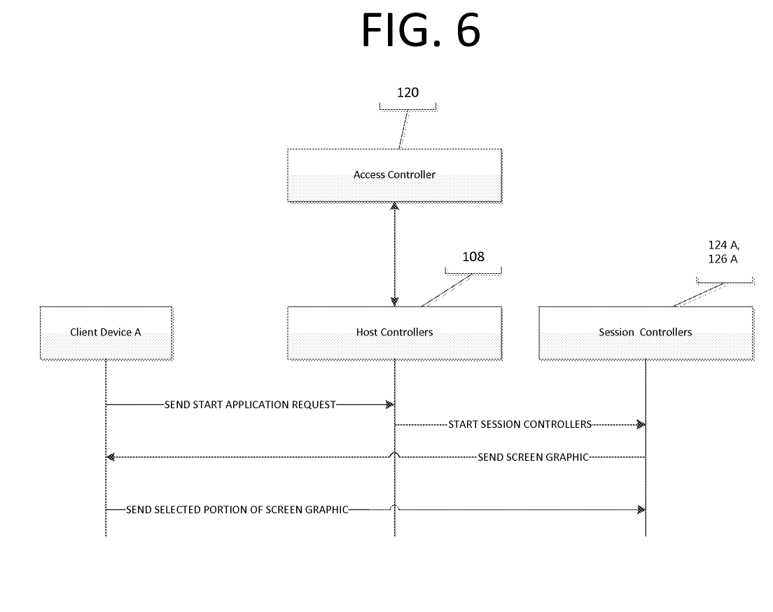

FIG. 6 illustrates an example communication process between the client device A and the computer server 102 of FIG. 1.

The client device A transmits data identifying the user interface configuration 114 to the computer server 102. Then, a specific host controller (from the host controllers 108) may establish a direct connection with the client device A and the computer server 102. The client device A may then transmit to the computer server 102 data requesting the computer server 102 to execute an application program.

The specific host controller may then establish session controllers 124A, 126A. The session controllers 124A, 126A characterize the user interface configuration 114 of the client device A. For example, the session controller 124A, 126A may characterize the display size of the client device A into equally sized identifiable rectangles. The characterized display size of the client device A may be stored in the computer server 102. Upon characterization of the display size, the session controllers 124A, 126A transmit data to the client device A (and the client device A receives data) representing a screen graphic of the requested application program to be displayed on the client device A.

Once the screen graphic is displayed, the client device A may then transmit to the computer server 102 (via the session controllers 124A, 126A) data representing a selection by a user of the client device A. For example, a user of the client device A may select a portion (e.g., an X, Y coordinate) of the screen graphic displayed on the display of the client device A. The selected portion may be selected by any suitable input command, including touching a display, a mouse click, a keyboard command, etc.

The session controllers 124A, 126A then may identify the selected portion from the characterized display size stored in the computer server 102. For example, if the display size is characterized by equally sized identifiable rectangles, the session controllers 124A, 126A may identify the selected portion (e.g., the X, Y coordinate) and correlate the selected portion to a particular rectangle of the equally sized identifiable rectangles.

Once the selected portion is identified, the session controllers 124A, 126A may transmit to the client device A data representing a new screen graphic to be displayed on the client device A.

Throughout the communication process, the aspect ratio of the screen graphics of the application program is preserved on the client device A. This is because the computer server 102 characterizes and stores the display size of the client device A.

It should be understood that the process described above may be continued until the application program is terminated by the client device A, until the communication network is lost, etc. Further, the process described above is applicable to other application programs (e.g., application program 106 of FIG. 3) and/or other client devices (e.g., the client device B).

In some example communication processes, a video driver of the client device A may be used to interpret screen interactions (e.g., selected portions of the screen graphic displayed) and the user interface configuration 114 of the client device A. For example, the client device A may transmit the X, Y coordinate of the selected portion through the video driver. The video driver may be any suitable video driver including a standard video driver specific to the operating system program of the client device A, a custom video driver installed on the client device A, etc.

Additionally, although the process described above relates to communication between the session controllers 124A, 126A and the client device A by pixel translation, any suitable process to transfer data may be employed.

By employing the teachings described herein, a computer system (e.g., the computer system 100) may remotely execute one or more application programs (e.g., the application programs 104, 106) on client devices (e.g., the client devices A, B) without building or rewriting each application program specifically for each client device. Accordingly, installation of each application program on each client device is not required.

The client devices A, B may be any suitable computing client device able to communicate via a communication network including smartphones, tablet computers, televisions, game consoles, monitors, etc. The client devices A, B may include memory (e.g., external drives (including secure digital (SD) cards, etc.), cloud, etc.) to store the client software 112, 112b, operating system program 110, 110b, etc. Additionally, client devices A, B may have any suitable operating system program and may be implemented in any suitable location including homes, motorized vehicles, non-motorized vehicles, nautical vehicles, aircrafts, satellites, weaponry, etc.

The application programs 104, 106 may be any suitable application program including game applications, educational applications, shopping applications, management applications, business applications, legacy applications (e.g., legacy java applications, etc.), computer applications, etc. The application programs may include batch files, fully executable applications, etc.

The computer server 102 may be any suitable server including physical servers (e.g., in-memory servers, etc.), virtual servers (e.g., cloud servers, etc.), etc. The computer server 102 may include any suitable operating system including Windows®, UNIX® (e.g., AIX®, Solaris®, Berkeley Software Distribution (BSD), etc.), Linux® (e.g., Red Hat®, SuSE®, etc.), etc. The computer server 102 may further include supported databases and unsupported databases (e.g., Oracle® databases, DB2® databases, Structured Query Language (SQL) databases, etc.). Further, the computer server 102 may include in-memory databases (e.g., SAP HANA™, etc.), etc.

Each host controller (of the host controllers 108) may be any suitable controller written in a programming language corresponding to the specific operating system program of the computer server 102.

Execution of the client software 112, 112B on the client devices A, B may result in any suitable function and/or screen display, including menu functions, keyboard functions, splash screens, login screens, registration screens, home screens, information screens, settings screens, etc.

The communication network may include an internet/intranet network, a cellular network connection, etc. The internet/intranet network may include any suitable wireless connection (e.g., WiFi connection, Bluetooth connection, etc.) or any suitable wired connection.

The memory 103 may include onboard and/or external memory, including removable and/or remote memory. For example, the memory 103 may include cloud storage, storage area network (SAN), network-attached storage (NAS), disks, SD cards, DVD, CD-ROMs, ROMs, RAMs, EPROMs, EEPROMs, DRAMs, VRAMs, flash memory devices, etc.

A non-transitory computer readable medium may store computer-readable instructions for performing the process as explained herein. The computer readable medium may be implemented within the computer server 102 (e.g., the memory 103), within the client device A and/or the client device B, external to the computer server 102, external to the client device A and/or the client device B, etc. The computer readable medium may include disks, SD cards, DVD, CD-ROMs, ROMs, RAMs, EPROMs, EEPROMs, DRAMs, VRAMs, flash memory devices, or any other suitable medium for storing instructions.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer system comprising a computer server having memory, an operating system program, and an application program stored in said memory and compatible with the operating system program, the computer server configured to establish via a communication network a direct connection with a client device having an operating system program different than the server's operating system program to permit a user of the client device to execute the application program on the computer server.

2. The computer system of claim 1 further comprising the client device.

3. The computer system of claim 2 wherein the client device includes client software, and wherein the server is configured to establish the direct connection with the client software of the client device via the communication network.

4. The computer system of claim 3 wherein the client device is a first client device, the computer system further comprising a second client device having client software and an operating system program different than the server's operating system program, wherein the computer server is configured to establish a direct connection with the client software of the second client device via the communication network to permit a user of the second client device to execute the application program on the computer server.

5. The computer system of claim 4 wherein the first client device and the second client device each has a user interface configuration, and wherein the user interface configuration of the first client device is different than the user interface configuration of the second client device.

6. The computer system of claim 5 wherein the operating system program of the first client device is different than the operating system program of the second client device.

7. (canceled)

8. The computer system of claim 5, wherein the computer server includes a first host controller for establishing the direct connection with the first client device and a second host controller for establishing the direct connection with the second client device.

9. The computer system of claim 1 further comprising an access controller for controlling access to the application program on the computer server by one or more client devices.

10.-11. (canceled)

12. The computer system of claim 1 wherein the computer server is configured to receive data identifying a user interface configuration of the client device.

13. The computer system of claim 1 wherein the computer server is configured to transmit to the client device data representing a screen graphic to be displayed on the client device.

14. The computer system of claim 13 wherein the computer server is configured to receive from the client device data representing a selection by a user of the client device.

15. (canceled)

16. The computer system of claim 14 wherein the computer server includes one or more session controllers for transmitting said data representing a screen graphic to be displayed on the client device and for receiving said data representing the selection by the user of the client device.

17. A client device comprising an operating system program and client software, the client software configured to communicate via a direct connection over a communication network with a computer server having an operating system program different than the client device's operating system program to execute an application program compatible with the computer server's operating system program on the computer server.

18. The client device of claim 17 wherein the client device is configured to transmit to the computer server data identifying a user interface configuration of the client device.

19.-21. (canceled)

22. A method for serving data via a direct connection over a communication network from a computer server having an operating system program, and an application program compatible with the operating system program to a client device having an operating system program different than the server's operating system program, the method comprising:
(a) transmitting to the client device data representing a screen graphic of the application program to be displayed on the client device, and
(b) receiving from the client device data representing a selection by a user of the client device.

23. (canceled)

24. The method of claim 22 wherein receiving from the client device data representing the selection by the user of the client device includes data representing a portion of the screen graphic selected by the user of the client device.

25.-26. (canceled)

27. A non-transitory computer readable medium storing computer-executable instructions for performing the method of claim 22.

28. A method of receiving data via a direct connection over a communication network by a client device having an operating system program from a computer server having an operating system program different than the client device's operating system program and an application program compatible with the computer server's operating system program, the method comprising:
(a) receiving from the computer server data representing a screen graphic of the application program to be displayed on the client device, and
(b) transmitting to the computer server data representing a selection by a user of the client device.

29. (canceled)

30. The method of claim 28 wherein transmitting to the computer server data representing the selection by the user of the client device includes data representing a portion of the screen graphic selected by the user of the client device.

31. A non-transitory computer readable medium storing computer-executable instructions for performing the method of claim 28.
